(19) United States
(12) Patent Application Publication
(10) Pub. No.: US 2025/0390527 A1
(43) Pub. Date: Dec. 25, 2025

(54) COMMUNICATION PROBLEM IDENTIFICATION DEVICE AND METHOD

(71) Applicant: MEDIATEK INC., Hsinchu City (TW)

(72) Inventors: Pei-Tsung WU, Hsinchu City (TW); Po-Wen HSIAO, Hsinchu City (TW); Wan-Ting HUANG, Hsinchu City (TW); Tsung-Ming LEE, Hsinchu City (TW)

(21) Appl. No.: 19/235,691

(22) Filed: Jun. 12, 2025

Related U.S. Application Data
(60) Provisional application No. 63/661,915, filed on Jun. 20, 2024.

(51) Int. Cl. G06F 16/334; H04W 24/08

(52) U.S. Cl. CPC G06F 16/3347; H04W 24/08

(57) ABSTRACT

A communication problem identification device is provided. The communication problem identification device includes a feature extraction module, a database module and an identification module. The feature extraction module is configured to encode communication-related information into an embedding vector. The database module is configured to store a plurality of reference vectors. Each reference vector corresponds to a respective issue type. The identification module is configured to determine the issue type of the communication-related information based on the embedding vector and the reference vectors.

### CROSS REFERENCE TO RELATED APPLICATIONS

This application claims priority of U.S. Patent Application No. 63/661,915, filed on Jun. 20, 2024, the entirety of which is incorporated by reference herein.

### BACKGROUND OF THE INVENTION

### Field of the Invention

The present invention relates to communication problem identification, and, in particular, to communication problem identification without a classification model.

### Description of the Related Art

A communication problem in mobile devices refers to abnormal or unexpected behavior that deviates from typical mobile communication patterns, or a degradation in the performance of a mobile device (e.g., User Equipment (UE)). These problems can include incompatibility between the camping cell frequencies of two active SIM cards, frequent disconnections, unstable handovers between cells, unexpected signal loss, unusually high data usage, or failure to connect to the network. Such behaviors may result from network congestion, hardware or software issues, misconfigurations, or even malicious activities. Therefore, detecting and addressing communication problems in mobile devices is essential to ensure stable connectivity, user satisfaction, and efficient use of network resources.

Traditionally, communication problems in mobile devices have been addressed using rule-based systems, manual analysis, and threshold-based monitoring. Mobile networks are configured with predefined parameters such as signal strength thresholds, handover margins, and timing constraints to detect and respond to abnormal behaviors or performance degradation. When an issue is detected-such as frequent handover failures, low signal quality, or unusual disconnections-engineers analyze logs and performance metrics to identify the root cause. Adjustments may be made to radio parameters, network configurations, or device firmware to resolve the issue.

However, these traditional approaches are limited in their ability to handle the increasing complexity, scale, and dynamism of modern mobile networks. As mobile devices generate vast amounts of heterogeneous data in real-time, it becomes difficult to manually define all possible problem patterns or maintain static thresholds. Additionally, these approaches often rely on expert knowledge and reactive analysis, which may lead to delays in detection and resolution.

Artificial intelligence (AI) and machine learning (ML) techniques are increasingly being applied to communication problem identification, offering intelligent, adaptive, and real-time solutions to detect unusual patterns in network traffic. By analyzing large volumes of data, AI/ML models can learn normal behavior patterns and identify deviations that may indicate security threats, system faults, or performance issues. Compared to traditional rule-based methods, AI/ML approaches provide higher accuracy, scalability, and the ability to detect previously unseen or evolving types of problems.

However, using an AI/ML model to detect all problems—especially novel ones—often falls short because the model may not generalize well to new or evolving issue patterns. While the model can detect known problems, unfamiliar ones introduce features the model has not been trained to recognize. Retraining is needed to adapt to new data. However, on mobile devices, this comes with a cost, and in some cases, may even be impractical. Retraining requires significant CPU and memory usage, drains battery life, and can slow down the system, impacting the overall user experience.

Therefore, a communication problem identification device and method that can solve the above problems are needed.

### BRIEF SUMMARY OF THE INVENTION

An embodiment of the present invention provides a communication problem identification device. The communication problem identification device includes a feature extraction module, a database module and an identification module. The feature extraction module is configured to encode communication-related information into an embedding vector. The database module is configured to store a plurality of reference vectors. Each reference vector corresponds to a respective issue type. The identification module is configured to determine the issue type of the communication-related information based on the embedding vector and the reference vectors.

An embodiment of the present invention provides a communication problem identification method. The communication problem identification method is executed by a computing device. The communication problem identification method includes: storing a plurality of reference vectors, each corresponding to a respective issue type; encoding communication-related information into an embedding vector; and determining the issue type of the communication-related information based on the embedding vector and the reference vectors.

In one embodiment, the identification module is further configured to: compare the embedding vector with each reference vector stored in the database module to identify a matched reference vector; and determine the issue type of the communication-related information according to the matched reference vector.

In one embodiment, the identification module is further configured to: in response to identifying no matched reference vector, store the embedding vector into the database module.

In one embodiment, the stored embedding vector is associated with a corresponding handler application based on a predefined rule set.

In one embodiment, the communication-related information is forwarded to the corresponding handler application after the identification module determines the issue type of the communication-related information.

In one embodiment, the handler application includes applications with following respective functions: reducing abnormal handovers; ignoring camping on pitfall cells; enhancing Dual SIM Dual Active (DSDA) match rate; and adjusting handover timing and target cell.

In one embodiment, the database module is regularly synchronized to a cloud.

In one embodiment, the identification module is further configured to: calculate a similarity score between the embedding vector and each of the reference vectors stored in the database module; and select, from the reference vectors stored in the database module, the reference vector with a highest similarity score as the matched reference vector.

In one embodiment, the identification module is further configured to: check whether the highest similarity score exceeds a predetermined threshold; in response to the highest similarity score exceeding the predetermined threshold, determine the issue type of the communication-related information according to the reference vector with a highest similarity; and in response to the highest similarity score not exceeding the predetermined threshold, store the embedding vector into the database module.

In one embodiment, the communication-related information includes at least one of following: a signal quality; a network configuration; and a communication performance metric.

The communication problem identification device and method provided herein enable resource-constrained devices (e.g., mobile device) to identify communication problem types without using a classification model. More specifically, by encoding the communication-related information and searching for the encoded communication-related information in the database, the communication problem identification device can determine the type of communication problem. In this way, when encountering a new and hard-to-identify issue, the communication problem identification device simply updates the database without retraining any model, which is more practical for the aforementioned resource-constrained devices.

### BRIEF DESCRIPTION OF THE DRAWINGS

The present invention can be more fully understood by reading the subsequent detailed description and examples with references made to the accompanying drawings, wherein:

FIG. 1 shows a system architecture diagram of a communication problem identification device, according to an embodiment of the present disclosure;

FIG. 2 is a data flow diagram of a communication problem identification method, according to an embodiment of the present disclosure;

FIG. 3 shows a flow diagram of a step of the communication problem identification method, according to an embodiment of the present disclosure; and

FIG. 4 shows another flow diagram of a step of the communication problem identification method, according to an embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the below embodiments, the same or similar elements or components will be represented by the same reference numerals.

The serial numbers in this description and the scope of the patent application, such as “first”, “second”, etc., are only for convenience of explanation, and there is no sequential relationship between them.

The description of the embodiments of the device or system in this disclosure also applies to the embodiments of the method, and vice versa.

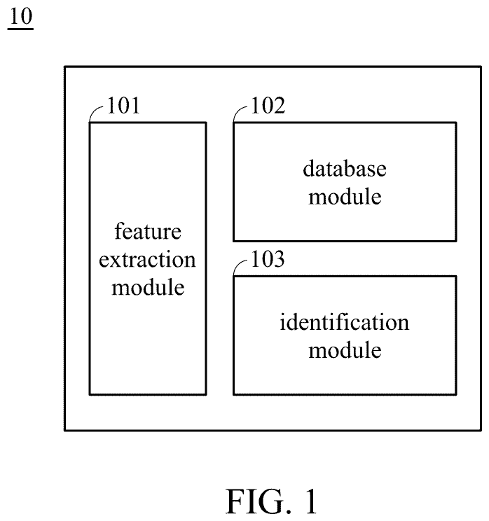

FIG. 1 shows a system architecture diagram of a communication problem identification device 10, according to an embodiment of the present disclosure. As shown in FIG. 1, the communication problem identification device 10 includes a feature extraction module 101, a database module 102 and an identification module 103.

The communication problem identification device 10 can be any computer device with limited computing capabilities, such as smartphones, tablets, wearable devices (e.g., smartwatches and fitness trackers), embedded systems, microcontrollers, or single-board computers (e.g., Raspberry Pi), but the present disclosure is not limited thereto.

The communication problem identification device 10 may include a processing unit. The processing unit may include any one or more general-purpose or special-purpose processors and combinations thereof for executing instructions, e.g., a central processing unit (CPU) and/or a graphics processing unit (GPU). The processing unit may also include volatile memories such as dynamic random access memory (DRAM) and/or static random access memory (SRAM) for temporarily holding data being used or processed during communication problem identification, but the present disclosure is not limited thereto.

In one embodiment, any of the feature extraction module 101, the database module 102 and the identification module 103 can be implemented using a dedicated integrated circuit, e.g., Application-Specific Integrated Circuit (ASIC), System on a Chip (SoC), or field-programmable gate array (FPGA), but the present disclosure is not limited thereto.

In another embodiment, any of the feature extraction module 101, the database module 102 and the identification module 103 can be software or firmware programs that can be loaded into the memory and executed by the aforementioned processing unit.

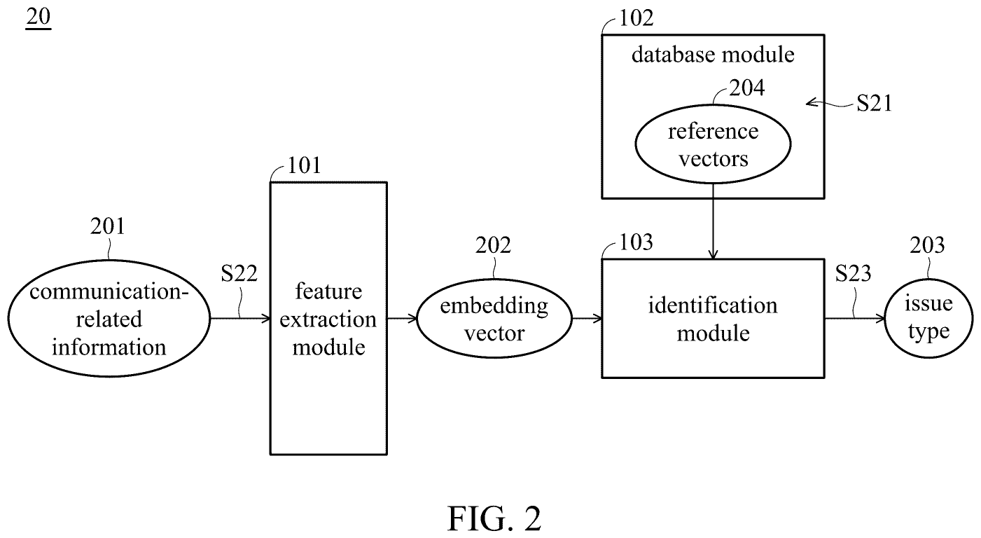

FIG. 2 is a data flow diagram of a communication problem identification method 20, according to an embodiment of the present disclosure. The communication problem identification method 20 can be executed by the communication problem identification device 10. As shown in FIG. 2, the communication problem identification method 20 includes steps S21 to S23. The following describes steps S21 to S23 in detail.

In step S21, the database module 102 may store a plurality of reference vectors 204. Each reference vector may correspond to a respective issue type. In step S22, the feature extraction module 101 may encode communication-related information 201 into an embedding vector 202.

In one embodiment, the communication-related information 201 may include a signal quality, a network configuration, or a communication performance metric.

The signal quality refers to physical measurements which can reflect the quality and strength of the network connection. For example, the signal quality may include signal quality metrics such as Received Signal Strength Indicator (RSSI), Reference Signal Received Power (RSRP), Reference Signal Received Quality (RSRQ), Signal to Interference plus Noise Ratio (SINR) or Channel Quality Indicator (CQI), but the present disclosure is not limited thereto.

The communication performance metric indicates how well the network is performing from the user's perspective. For example, the communication performance metric may include throughput, latency, packet loss, jitter, error rate, availability, connection setup time, signal-to-noise ratio (SNR), session duration, handover success/failure rate, round-trip time (RTT), access success rate, load balancing efficiency, or data transfer speed, but the present disclosure is not limited thereto.

The network configuration refers to parameters that define how a device or network is set up and operates to enable communication. For example, the network configuration may include cell identifier (ID), frequency band setting, handover parameters (e.g., thresholds, timers), carrier aggregation settings, power control parameters, random-access channel (RACH) parameters, Quality of Service (QOS) configuration, network slice settings, network slice settings, or security settings. For another example, the network configuration may include the number of supported frequency bands, supported radio access technologies (e.g., LTE, 5G NR), carrier aggregation capabilities, Multiple-Input Multiple-Output (MIMO) support, dual SIM configurations (e.g., DSDA), supported modulation schemes (e.g., 256-QAM), maximum transmit power, user equipment (UE) category and maximum throughput, power class, roaming preferences and Public Land Mobile Network (PLMN) selection modes, 5G network slicing support, Discontinuous Reception (DRX) settings, Non-Standalone/Standalone (NSA/SA) architecture compatibility, RRC feature support, location service capabilities (e.g., Assisted Global Positioning System (A-GPS), observed-time-difference-of-arrival (OTDOA)), and IP Multimedia Subsystem related (IMS-related) features (e.g., Voice over LTE (VOLTE) and Voice over New Radio (VoNR)) support, but the present disclosure is not limited thereto.

In one embodiment, the communication-related information 201 may be represented as a vector. For example, the communication-related information 201 may be [−70, 18, 123, 2.4, 2, 50, 20, 2], where −70 represents the RSSI in dBm, 18 represents the SINR in dB, 123 represents the cell tower ID, 2.4 represents the frequency band in GHz, 2 represents the modulation scheme (16-QAM), 50 represents the throughput in Mbps, 20 represents the latency in milliseconds, and 2 represents the packet loss rate in percentage. It should be noted that the above is a simplified example. In real-world applications, the communication-related information 201 can have a much higher dimensionality.

In one embodiment, the feature extraction module 101 may be implemented using the whole or a part of any AI/ML model that can be used for embedding, e.g., Word2Vec, GloVe, Autoencoders (AE), Convolutional Neural Networks (CNN), Deep Belief Networks (DBN), Variational Autoencoders (VAE), or t-SNE, but the present disclosure is not limited thereto.

The AI/ML model applied in the feature extraction module 101 may be trained using unsupervised learning. Since the feature extraction module 101 can learn patterns, structures, or relationships within the data itself, labeled data may be unnecessary. Take an AE model as an example. During training, the input data is first encoded into a lower-dimensional latent vector through the encoder. Then, the decoder attempts to reconstruct the original input from this latent vector. The model is optimized by minimizing the reconstruction loss, such as mean squared error between the original input and the reconstructed output. As training progresses, the encoder learns to generate compact and meaningful embeddings that capture the essential features of the input data. Then, the trained encoder can be applied as the feature extraction module 101.

In one embodiment, the feature extraction module 101 may perform embedding operation on the communication-related information 201. “Embedding operation” refers to the process of mapping high-dimensional or categorical data (like words, images, or objects) into a lower-dimensional vector space. This operation helps transform complex, discrete, or sparse data into dense, continuous, and fixed-size vector representations that capture the inherent structure, patterns, or relationships in the data.

After the embedding operation, the high-dimensional communication-related information 201 may be embedded/compressed into the low-dimensional embedding vector 202. For example, the communication-related information 201 may be an 20-dimensional vector, [−70, 18, 123, 2.4, 2, 50, 20, 2, 3, 5, 1, 1024, 0, 12, 7, 0.01, 256, 4, 300, 99]. Then, the embedding vector 202 may be a 7-dimensional vector, [0.32, −0.54, 0.61, 0.12, −0.25, 0.47, 0.58], which has a lower dimension than the communication-related information 201.

In one embodiment, the reference vector 204 may have the same dimension and represent similar types of features in the same order as the embedding vector 202. For example, the embedding vector 202 may be a 7-dimensional vector, [0.68, −0.18, 0.08, 0.60, −0.12, 0.52, 0.28]. Then, the reference vector 204 may be another 7-dimensional vector, [0.80, −0.10, 0.05, 0.75, −0.05, 0.45, 0.30].

In one implementation, to ensure having consistent dimensions and aligned feature meanings, the embedding vector 202 and the reference vector 204 may be generated by the same model or by models that follow an identical feature extraction process. For example, both of the embedding vector 202 and the reference vector 204 are generated by the same VAE model or by two separate VAE models with the same model parameters.

In one implementation, depends on the application requirements (e.g., data structure, query needs, and performance demands), the database module 102 may be implemented using local file system, SQL database (e.g., SQLite) or NoSQL database (e.g., Realm, Couchbase Lite, Core Data, Room), but the present disclosure is not limited thereto.

Notably, embedding operation offer several key benefits, particularly when dealing with different types of input data. It allows high-dimensional and complex data—such as signal quality, network configuration and communication performance metric—to be transformed into compact, continuous, and meaningful vector representations. This transformation makes it easier for resource-constrained devices to process and understand various types of data. Furthermore, embedding operation reduces dimensionality, which improves computational and storage efficiency, and further speeds up processing time.

In step S23, the identification module 103 may determine the issue type 203 of the communication-related information 201 based on the embedding vector 202 and the reference vectors 204.

In one embodiment, the issue type 203 may include abnormal handover loops, phantom cell connections, radio link failures under good signal conditions, ping-pong handovers, coverage holes in overlapping areas, hidden cell interference, high packet error rates despite good radio conditions, abnormal dormancy and wakeup behavior, backhaul congestion impacting the radio access network, and incorrect Radio Resource Control (RRC) state transitions, but the present disclosure is not limited thereto.

In one embodiment, the identification module 103 may be implemented using machine learning models (e.g., Siamese networks, triplet networks, and contrastive learning frameworks), which may be trained using supervised learning. The training data may be generated by collecting, then embedding and finally labeling raw data (such as signal qualities, network configurations, and communication performance metrics) with a specific issue type based on expert analysis or predefined rules.

In another embodiment, the identification module 103 may be implemented using similarity-based approaches such as cosine similarity and Euclidean distance. Specifically, the identification module 103 may determine whether the embedding vector 202 matches the reference vectors 204 by calculating the similarity between the embedding vector 202 and the reference vectors 204, and then determine the issue type 203 of the communication-related information 201 accordingly.

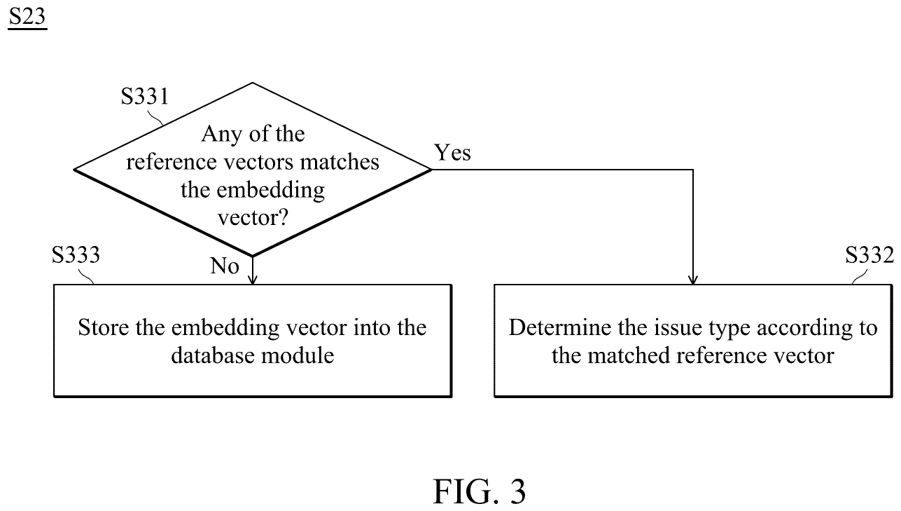

FIG. 3 shows a flow diagram of step S23 of the communication problem identification method 20, according to an embodiment of the present disclosure. As shown in FIG. 3, step S23 may further include steps S331˜S333. The following illustrates steps S331˜S333 in detail.

In step S331, the identification module 103 may compare the embedding vector 202 with each reference vector stored in the database module 102 to identify a matched reference vector. If there is matched reference vector, the identification module 103 may proceed to step S332. If there is no matched reference vector the identification module 103 may proceed to step S333.

In step S332, the identification module 103 may determine the issue type of the communication-related information according to the matched reference vector. For example, if the matched reference vector indicates cell reselection failure, it can be determined that the issue type of the communication-related information is also “cell reselection failure”.

In one implementation, the database module 102 may store a mapping between a reference vector and an issue type. The mapping may be pre-determined based on expert analysis or predefined rules.

<Table 1> shows an example of mappings between reference vectors and issue types. Descriptions for each issue type are also provided. As shown in <Table 1>, the database module 102 may store one reference vector for each issue type. Each reference vector stored in the database module 102 may be representative data provided by domain experts.

TABLE 1

| | issue | |
|---|---|---|
| reference vector | type | description |
| [−72, 15, 101, 2.6, 1, 35, 45, 3] | 0 | High packet loss in mid-band |
| | | frequency |
| [−85, 5, 205, 3.5, 2, 10, 120, 8] | 1 | Poor signal quality causing |
| | | handover failure |
| [−80, 4, 198, 4.0, 3, 12, 115, 7] | 2 | incompatibility between the |
| | | camping cell frequencies of |
| | | two active SIM cards |
| . . . | . . . | . . . |
| [−65, 20, 112, 2.1, 1, 80, 25, 1] | N | Sudden drop in throughput |
| | | due to interference |

Specifically, the identification module 103 may look up the mapping table (e.g., <Table 1>) stored in the database module 102, compare the embedding vector 202 with each reference vector in the mapping table to identify a matched reference vector, and take the issue type corresponding to the matched reference vector in the mapping table as the issue type of the communication-related information.

For example, the embedding vector 202 is [−85, 5, 205, 3.5, 2, 10, 120, 8]. The embedding vector 202 completely matches the reference vector [−85, 5, 205, 3.5, 2, 10, 120, 8] in the mapping table <Table 1>. According to the mapping table <Table 1>, the issue type corresponding to the matched reference vector is 1. Therefore, the identification module 103 may determine that the issue type of the communication-related information is denoted by 1, that is, “Poor signal quality causing handover failure.”

In one embodiment, the identification module 103 may calculate a similarity score between the embedding vector 202 and each of the reference vectors stored in the database module 102, and select the reference vector with the highest similarity score as the matched reference vector.

In one implementation, the similarity score may be obtained based on a mathematical function, e.g., cosine similarity, Euclidean distance, or Manhattan distance. The function result may reflect how similar or different the two vectors are. Cosine similarity provides a direct similarity score ranging from −1 to 1, where higher values indicate greater similarity. For example, cosine similarity of 0.97 indicates that the two vectors are nearly identical. Euclidean distance and Manhattan distance are distance metrics, where lower values indicate higher similarity. These distances may be further converted into similarity scores by using an inverse transformation, such as similarity=1/(1+distance), where the similarity score gradually approaches 0 as the distance increases.

For example, the embedding vector 202 is [−85, 5, 205, 3, 2, 10, 120, 8]. The similarity score calculated using cosine similarity between the embedding vector 202 and the reference vector [−72, 15, 101, 2.6, 1, 35, 45, 3] is 0.9414. The similarity score between the embedding vector 202 and the reference vector [−85, 5, 205, 3.5, 2, 10, 120, 8] is 0.999998. The similarity score between the embedding vector 202 and the reference vector [−85, 5, 205, 3.5, 2, 10, 120, 8] is 0.8243. These values indicate that the embedding vector 202 is most similar to the reference vector [−85, 5, 205, 3.5, 2, 10, 120, 8]. Therefore, the reference vector [−85, 5, 205, 3.5, 2, 10, 120, 8] may be selected as the matched reference vector. According to the mapping table <Table 1>, the issue type corresponding to the matched reference vector is denoted 1, that is, “Poor signal quality causing handover failure.” Therefore, the identification module 103 may determine that the issue type of the communication-related information is “Poor signal quality causing handover failure.”.

In step S333, the identification module 103 may determine that the communication-related information 201 is a new issue type. Therefore, the identification module 103 may store the embedding vector 202 into the database module 102, so as to enable the database module 102 to track the latest communication problems.

In one embodiment, before storing the embedding vector 202 into the database module 102, the issue type of the communication-related information 201 may first be determined by experts or a predefined rule set. The predefined rule set may include, for example, the following:
(1) If handover failure rate >20% over 10 events, then the communication problem may be ‘abnormal handover behavior’.
(2) If cell reselection count >5 in 60 seconds, then the communication problem may be ‘possible radio instability’.
(3) If RRC connection attempts >3 within 60 seconds, then the communication problem may be ‘suspect RRC failure’.

For example, the embedding vector 202 is [120, −60, −150, −4, −3, −70, −90, −10]. Since not completely matching any reference vector in the mapping table <Table 1>, the embedding vector 202 may undergo additional processing to determine its issue type. After its issue type is determined, the embedding vector 202 and its issue type (e.g., cell reselection failure) may be inserted into the mapping table <Table 1> as a new table entry. <Table 1> finally appears as shown in <Table 2>.

TABLE 2

| | issue | |
|---|---|---|
| reference vector | type | description |
| [−72, 15, 101, 2.6, 1, 35, 45, 3] | 0 | High packet loss in |
| | | mid-band frequency |
| [−85, 5, 205, 3.5, 2, 10, 120, 8] | 1 | Poor signal quality |
| | | causing handover |
| | | failure |
| . . . | . . . | . . . |
| [−65, 20, 112, 2.1, 1, 80, 25, 1] | N | Sudden drop in |
| | | throughput due to |
| | | interference |
| [120, −60, −150, −4, −3, −70, −90, −10] | N + 1 | Cell reselection |
| | | failure |

In one embodiment, the communication problem identification device 10 may regularly sync the database module 102 to a cloud. Specifically, each communication problem identification device may upload the mapping table from its database module to the cloud using APIs or synchronization protocols. The cloud may maintain a global mapping table that summarizes the mapping table received from each device. Then, each communication problem identification device can download the updated global mapping table to update its database module, again using APIs or synchronization protocols.

Notably, syncing the database module 102 to the cloud ensures that newly observed issues are quickly shared and made accessible across multiple devices. This can reduce duplicated efforts, facilitate faster troubleshooting and resolution, and thereby improve overall network reliability and user experience.

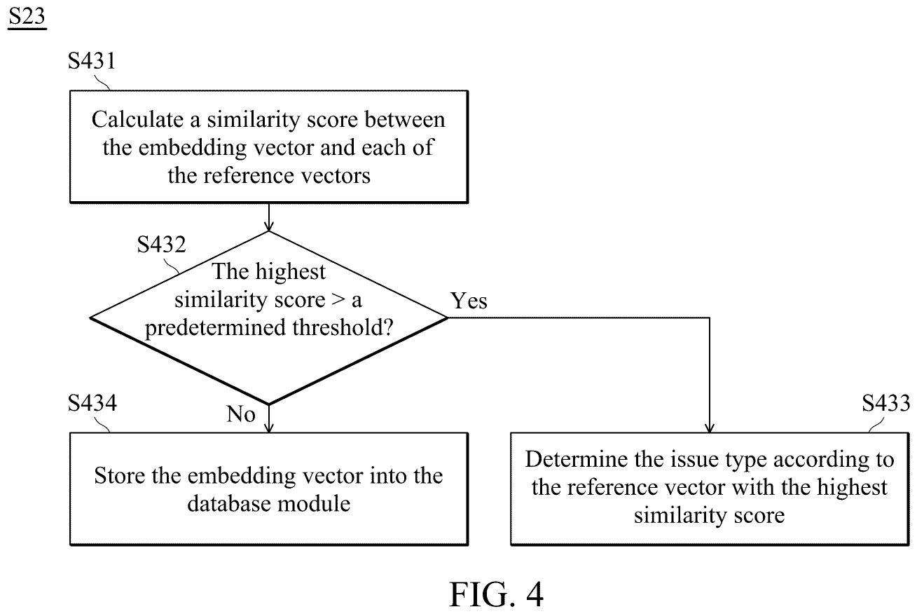

FIG. 4 shows another flow diagram of step S23 of the communication problem identification method 20 according to another embodiment of the present disclosure. As shown in FIG. 4, step S23 further includes steps S431˜S434. The following illustrates steps S431˜S434 in detail.

In step S431, the identification module 103 may calculate a similarity score between the embedding vector 202 and each of the reference vectors stored in the database module 102.

In step S432, the identification module 103 may select the highest similarity score and check whether the highest similarity score exceeds a predetermined threshold, e.g., 90%. If the highest similarity score exceeds the predetermined threshold, it represents that the embedding vector 202 and the selected reference vector are considered highly similar. Then, the identification module 103 proceeds to step S433. If the highest similarity score falls below the predetermined threshold, it represents that the embedding vector 202 and the selected reference vector are dissimilar or not sufficiently close. Then, the identification module 103 proceeds to step S434.

In one implementation, the predefined threshold is typically determined through a combination of empirical testing and statistical analysis. During the development phase of the identification module 103, a validation dataset containing known matches and non-matches is used to evaluate similarity scores. By analyzing the distribution of these scores, developers can identify a cutoff point that balances precision and recall-maximizing correct matches while minimizing false positives. This threshold can also be adjusted based on the acceptable risk level of misclassification in the specific application.

In step S433, the identification module 103 may choose the reference vector with the highest similarity score as the matched reference vector, and determine the issue type 203 of the communication-related information according to the matched reference vector.

For example, the embedding vector 202 is [−85, 5, 205, 3, 2, 10, 120, 8], and the predefined threshold is 0.9. The similarity score between the embedding vector 202 and the reference vector [−72, 15, 101, 2.6, 1, 35, 45, 3] is 0.9414. The similarity score between the embedding vector 202 and the reference vector [−85, 5, 205, 3.5, 2, 10, 120, 8] is 0.999998. The similarity score between the embedding vector 202 and the reference vector [−85, 5, 205, 3.5, 2, 10, 120, 8] is 0.8243. The reference vector [−85, 5, 205, 3.5, 2, 10, 120, 8] has the highest similarity score 0.9414 and this score is over the predefined threshold. Therefore, the reference vector [−85, 5, 205, 3.5, 2, 10, 120, 8] may be selected as the matched reference vector. According to the mapping table <Table 1>, the issue type corresponding to the matched reference vector is denoted by 1, that is, “Poor signal quality causing handover failure.” Therefore, the identification module 103 may determine that the issue type of the communication-related information is “Poor signal quality causing handover failure.”.

In step S434, the identification module 103 may determine that the communication-related information 201 is a new issue type. Therefore, the identification module 103 may store the embedding vector 202 into the database module 102, so as to ensure the database module 102 can track the latest communication problems.

For example, the embedding vector 202 is [120, −60, −150, −4, −3, −70, −90, −10] and the predefined threshold is 0.9. The similarity scores between the reference vectors [−72, 15, 101, 2.6, 1, 35, 45, 3], [−85, 5, 205, 3.5, 2, 10, 120, 8] and [−85, 5, 205, 3.5, 2, 10, 120, 8] are respectively −0.90, −0.98 and −0.90. Since these similarity scores all fall below the predefined threshold, the embedding vector 202 may undergo additional processing to determine its issue type. Then, the embedding vector 202 and its issue type (e.g., cell reselection failure) may be inserted into the mapping table <Table 1> as shown in <Table 2>.

Notably, compared to the rule-based method, the similarity-based method herein is more flexible and adaptable to complex or unseen patterns. This approach does not completely rely on manually crafted rules, which can be time-consuming to create and may fail to capture subtle or evolving behaviors. Instead, this approach can generalize from data, making them better suited for dynamic environments or problems that deviate from predefined rules.

In one embodiment, the database module 102 may further store a mapping between a reference vector and a handler application. Specifically, the database module 102 may store a link to the handler application, e.g., an address, a function reference, a URL endpoint, or a module path. The mapping may be determined based on expert analysis or predefined rules.

In one embodiment, the handler application may include respective applications that can reduce abnormal handovers, ignore camping on pitfall cells, enhance Dual SIM Dual Active (DSDA) match rate, and/or adjust handover timing and target cell, but the present disclosure is not limited thereto.

In one implementation, the handler application can be implemented as a program (e.g., function or script) that can run in the background, so that it can automatically trigger appropriate responses without requiring user intervention when a communication problem is detected.

<Table 3> shows an example of mappings among reference vectors, issue types and file paths to handler applications. For example, issue type 0 indicates abnormal handovers, and its corresponding handler application ‘abnormal_handover_reducer.py’ is a Python application designed to reduce abnormal handovers.

TABLE 3

| | issue | |
|---|---|---|
| reference vector | type | handler application |
| [−72, 15, 101, 2.6, 1, 35, 45, 3] | 0 | /data/system/handlers/ |
| | | abnormal_handover_reducer.py |
| [−85, 5, 205, 3.5, 2, 10, 120, 8] | 1 | /data/system/handlers/ |
| | | dsda_match_rate_enhancer.py |
| . . . | . . . | . . . |
| [−65, 20, 112, 2.1, 1, 80, 25, 1] | N | /data/system/handlers/ |
| | | handover_timing_adjuster.py |

<Table 4> shows another example of mappings between reference vectors and function pointers to handler applications. The function pointers are represented in hexadecimal format. In this example, the columns for issue types are unnecessary and thus are removed.

TABLE 4

| reference vector | handler application |
|---|---|
| [−72, 15, 101, 2.6, 1, 35, 45, 3] | 0x7f8a3240 |
| [−85, 5, 205, 3.5, 2, 10, 120, 8] | 0x4010a000 |
| . . . | . . . |
| [−65, 20, 112, 2.1, 1, 80, 25, 1] | 0xffe3bc90 |

In one embodiment, the communication-related information 201 is further forwarded to the corresponding handler application.

For example, the communication problem identification device 10 may obtain the issue type 203 from the identification module 102, then look up the mapping table (e.g., <Table 3>) stored in the database module, and forward the communication-related information 201 to the handler application corresponding to the issue type 203.

For another example, the communication problem identification device 10 may obtain a link (e.g., pointer, file path or address) to the corresponding handler application from the identification module 102 and then forward the communication-related information 201 to the handler application.

In one embodiment, the communication-related information 201 may be forwarded by using an application program interface (API) call, a message queue, a database, a file or a function call, but the present disclosure is not limited thereto.

The communication problem identification device and method provided herein enable resource-constrained devices (e.g., mobile device) to identify communication problem types without using a classification model. More specifically, by encoding the communication-related information and searching for the encoded communication-related information in the database, the communication problem identification device can determine the type of communication problem. In this way, when encountering a new and hard-to-identify issue, the communication problem identification device simply updates the database without retraining any model, which is more practical for the aforementioned resource-constrained devices.

The above paragraphs are described in various ways. Obviously, the teachings of this article can be implemented in a variety of ways, and any specific architecture or functionality disclosed in the examples is only a representative situation. Based on the teachings of this article, it should be understood in the art that each aspect disclosed in this article can be implemented independently, or two or more aspects can be combined and implemented.

Although the present disclosure has been described using embodiments as above, they are not intended to limit the present disclosure. A person skilled in the art may make some modifications without departing from the spirit and scope of the present disclosure. Therefore, the protection scope of the disclosure shall be determined by the appended patent application scope.

What is claimed is:

1. A communication problem identification device, comprising:
a feature extraction module, configured to encode communication-related information into an embedding vector;
a database module, configured to store a plurality of reference vectors, each corresponding to an issue type; and
an identification module, configured to determine the issue type of the communication-related information based on the embedding vector and the reference vectors.

2. The communication problem identification device as claimed in claim 1, wherein the identification module is further configured to:
compare the embedding vector with each reference vector stored in the database module to identify a matched reference vector; and
determine the issue type of the communication-related information according to the matched reference vector.

3. The communication problem identification device as claimed in claim 2, wherein the identification module is further configured to:
in response to identifying no matched reference vector, store the embedding vector into the database module.

4. The communication problem identification device as claimed in claim 3, wherein the stored embedding vector is associated with a corresponding handler application based on a predefined rule set.

5. The communication problem identification device as claimed in claim 4, wherein the communication-related information is forwarded to the corresponding handler application after the identification module determines the issue type of the communication-related information.

6. The communication problem identification device as claimed in claim 4, wherein the handler application comprises applications with at least one of following respective functions:
reducing abnormal handovers;
ignoring camping on pitfall cells;
enhancing Dual SIM Dual Active (DSDA) match rate; and
adjusting handover timing and target cell.

7. The communication problem identification device as claimed in claim 3, wherein the database module is regularly synchronized to a cloud.

8. The communication problem identification device as claimed in claim 2, wherein the identification module is further configured to:
calculate a similarity score between the embedding vector and each of the reference vectors stored in the database module; and
select, from the reference vectors stored in the database module, the reference vector with a highest similarity score as the matched reference vector.

9. The communication problem identification device as claimed in claim 8, wherein the identification module is further configured to:
check whether the highest similarity score exceeds a predetermined threshold;
in response to the highest similarity score exceeding the predetermined threshold, determine the issue type of the communication-related information according to the reference vector with a highest similarity; and
in response to the highest similarity score not exceeding the predetermined threshold, store the embedding vector into the database module.

10. The communication problem identification device as claimed in claim 1, wherein the communication-related information comprises at least one of following:
a signal quality;
a network configuration; and
a communication performance metric.

11. A communication problem identification method, executed by a computing device, the method comprising:
storing a plurality of reference vectors, each corresponding to a respective issue type;
encoding communication-related information into an embedding vector; and
determining the issue type of the communication-related information based on the embedding vector and the reference vectors.

12. The communication problem identification method as claimed in claim 11, further comprising:
comparing the embedding vector with each reference vector stored to identify a matched reference vector; and
determining the issue type of the communication-related information according to the matched reference vector.

13. The communication problem identification method as claimed in claim 12, further comprising:
in response to identifying no matched reference vector, storing the embedding vector.

14. The communication problem identification method as claimed in claim 13, further comprising:
associating the stored embedding vector with a corresponding handler application based on a predefined rule set.

15. The communication problem identification method as claimed in claim 14, further comprising:
after the identification module determines the issue type of the communication-related information, forwarding the communication-related information to the corresponding handler application.

16. The communication problem identification method as claimed in claim 14, wherein the handler application comprises applications with at least one of following respective functions:
reducing abnormal handovers;
ignoring camping on pitfall cells;
enhancing Dual SIM Dual Active (DSDA) match rate; and
adjusting handover timing and target cell.

17. The communication problem identification method as claimed in claim 13, further comprising syncing the database module to a cloud.

18. The communication problem identification method as claimed in claim 12, further comprising:
calculating a similarity score between the embedding vector and each of the reference vectors stored; and
selecting, from the reference vectors stored in the database module, the reference vector with a highest similarity score as the matched reference vector.

19. The communication problem identification method as claimed in claim 18, further comprising:
checking whether the highest similarity score exceeds a predetermined threshold;
in response to the highest similarity score exceeding the predetermined threshold, determining the issue type of the communication-related information according to the reference vector with a highest similarity; and
in response to the highest similarity score not exceeding the predetermined threshold, storing the embedding vector.

20. The communication problem identification method as claimed in claim 11, wherein the communication-related information comprises at least one of following:
a signal quality:
a network configuration; and
a communication performance metric.
